(19) United States
(12) Patent Application Publication
(10) Pub. No.: US 2004/0239969 A1
(43) Pub. Date: Dec. 2, 2004

(54) Image processing apparatus and method

(75) Inventors: Hirokazu Shoda, Yokohama-shi (JP); Takayuki Sawada, Numazu-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/694,981

(22) Filed: Oct. 29, 2003

(30) Foreign Application Priority Data
May 28, 2003 (JP) 2003-150851

(51) Int. Cl. H04N 1/60

(52) U.S. Cl. 358/1.9; 358/518

(57) ABSTRACT

An image processing apparatus including an input section configured to receive color image signals, a printing color designation section configured to designate printing colors of two colors, a conversion section configured to convert the color image signals which are received from the input section to be converted to two-state signals in a dimension-dropped fashion, and a color allocation section configured to allocate the printing colors of two colors which are designated by the printing color designation section to the converted two-state signals.

### CROSS-REFERENCE TO RELATED APPLICATIONS

This application is based upon and claims the benefit of priority from the prior Japanese Patent Application No. 2003-150851, filed May 28, 2003, the entire contents of which are incorporated herein by reference.

### BACKGROUND OF THE INVENTION

1. Field of the Invention

The present invention relates to an image processing apparatus and method directed to, with respect to input color image signals, effecting printing with the use of designated two colors.

2. Description of the Related Art

In recent years, an image processing apparatus, such as a digital color copier, has been proposed in which a scanned document image is printed with the use of two colors, such as black and red, designated by the user on a control panel. An image processing method has also been proposed in which, when printing is done with the use of such two colors, direct conversion is made, for example, from the input RGB signals to black and red signals as output colors by virtue of matrix calculation. In the case where CMYK signals of black and red are calculated direct from the RGB signals by such matrix calculation, color turbidity occurs due to the mixing of unwanted C and K color signals into a wanted red color signal and mixing of unwanted CMY color signals into a black color signal. The occurrence of such color turbidity is due to the fact that it has been difficult to find a matrix coefficient with which, for the RGB signals of 256 color tones, two colors of red and black are reproduced as single colors with the CMYK signals and with which no tone inversion occurs.

In order to avoid the occurrence of the color turbidity, another method has been proposed. In this method, concentration conversion processing is done on the RGB signal input from a scanner to produce a monochrome signal and color conversion processing is done to obtain CMY signals from the RGB signals. After these, hue decision processing and saturation decision processing are done as set out below. That is, under the hue and saturation decision processing, printing decision is made by applying either one of two colors black and red to a corresponding one pixel unit and concentration conversion is made on the decided printing color and printing is made with a corresponding concentration signal.

In the proposed method, it is necessary to provide extra circuits for such hue and saturation decision and an extra cost is required for such circuits. Further, since the signals are converted to black and red and a printing processing operation is made for effecting direct printing, it is not possible to change the processing in a manner to correspond to a character area and picture area in an image.

There is a growing demand for an image processing apparatus and method which can reduce color turbidity at a time of color printing and a manufacturing cost involved.

### BRIEF SUMMARY OF THE INVENTION

In one aspect of the present invention there is provided an image processing apparatus comprising an input section, such as a scanner, configured to receive color image signals, a printing color designating section, such as a control panel, configured to designate printing colors of two colors, a conversion section configured to receive the color image signals which are received at the input section and convert the color image signals to two-state signals in a signal dimension-dropped fashion, and a color allocating section configured to allocate the printing colors of two colors which are designated by the printing color designating section to the converted two-state signals.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 shows a schematic arrangement of an image processing apparatus in a first embodiment of the present invention;

FIG. 2 is a view showing an LUT for color conversion processing;

FIG. 3 is a view showing an achromatic/chromatic color boundary;

FIG. 4 is a view showing a schematic form of an inking processing section;

FIG. 5 is a view showing an LUT for inking processing;

FIG. 6 is a view showing the allocation of CMY subtraction signals to output signals;

FIG. 7 is a view showing an arrangement of an image processing apparatus in a second embodiment of the present invention;

FIG. 8 is a conceptual view of a two-dimensional plane for saturation decision;

FIG. 9 is a view showing another form of an image processing apparatus;

FIG. 10 is a view showing an arrangement of a fourth embodiment of the present invention;

FIG. 11 is a view showing another form of the image forming apparatus; and

FIG. 12 is a conceptual view showing a two-dimensional plane for finding saturation information.

### DETAILED DESCRIPTION OF THE INVENTION

The respective embodiments of the present invention will be described below with reference to the drawing.

### FIRST EMBODIMENT

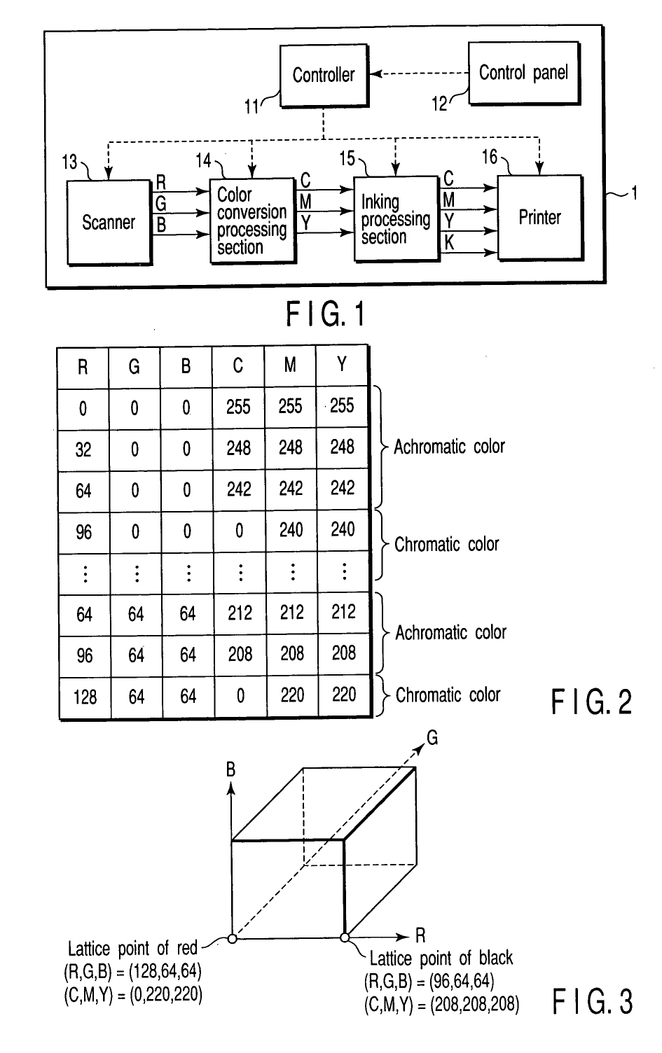

FIG. 1 shows a schematic arrangement of an image processing apparatus 1. The image processing apparatus 1 includes a controller 11, a control panel 12, a scanner 13, a color conversion processing section 14, an inking processing section 15 and a printer 16.

The controller 11 comprises a CPU, a ROM, a RAM, etc., not shown. The controller 11 receives an instruction from a control panel 12 and generally controls a whole of the image processing apparatus 1 including the scanner 13, color conversion processing section 14, inking processing section 15, printer 16, etc.

To the control panel 12 an instruction is given by a user to allow it to be applied to the controller 11. The control panel includes, for example, an input section having various kinds of functional keys such as a copy start key, numeral keys, and so on, as well as a display section for informing necessary information to the user. By operating the input section of the control panel 12, the user can give an instruction to designate two colors coping for outputting a copy in two colors as well as to designate such two colors (printing color designating section). Here, an explanation will be given below about the case of designating black and red as the two colors for two-color copying.

The scanner 13 scans an image of a document set in a given place, not shown, or an image of each of a plurality of document sheets fed from, for example, an automatic document feeder (ADF), not shown, generates RGB signals of red (R), green (G) and blue (B), and inputs the RGB signals to the color conversion processing section 14 (input section). It is to be noted that the scanner 13 is of an ordinary type and further explanation of it is, therefore, omitted.

The color conversion processing section 14 receives the RGB signals from the scanner 13 and applies color conversion processing to these signals and generates CMY signals of cyan (C), magenta (M), and yellow (Y). In this connection it is to be noted that the color conversion processing to be done by the color conversion processing section 14 is carried out in a look-up table (LUT) system. One example of the color conversion LUT system is shown in FIG. 2. The color conversion LUT set in the color conversion processing section 14, while referring to color conversion parameters shown in FIG. 2, enables the RGB signals which correspond to a full set of color signals coming from the scanner 13 to be converted to two-state signals, chromatic and achromatic. The color conversion parameters are so set that, for example, the achromatic color area in the RGB space is output as “black” and the chromatic color area as “red”. The color states output by the use of the parameters shown in FIG. 2 correspond to the following two kinds. That is, when the RGB signals are all in an equal amount (achromatic), C=M=Y (black), while, on the other hand, when the RGB signals are not in an equal amount (chromatic), C=0 and M=Y (red). The reason why the achromatic and chromatic colors extracted by the color conversion processing are output as black and red is because the same path as that in the case of conventional full-color copying is used. Thus, this can be realized simply by changing the color conversion parameters in the color conversion LUT for use in the normal copying processing. By doing so, it is not necessary to newly add any extra image processing circuit for color extraction and it is possible to lower the hardware cost in comparison with that for the conventional apparatus. Since the RGB signals are converted to the two-state signals, that is, achromatic and chromatic color signals, and, hence, conversion is made to a one-dimension-dropped image space against a three-dimension color space, it is possible to achieve high-speed processing.

As set out above, the color conversion processing of the color conversion processing section 14 is the processing using the color conversion LUT and, as shown in FIG. 3, it follows that, with respect to those areas other than the lattice points of the RGB space, CMY signals are found by interpolation calculation. For this reason, a cyan signal is taken such as at C≠0 M≠C and Y. The mixing of the cyan color into a color to be extracted as a chromatic color area in the vicinity of an achromatic/chromatic color boundary (this is not a red color signal replaced by chromatic color information such as C≠0 and M=Y) means extracting it as a color closer to the achromatic color (it is to be noted that the reverse may occur). Therefore, there occurs the case where the turbidity of color emerges in the vicinity of the achromatic/chromatic color boundary. In the case where the chromatic color is extracted as an achromatic color and color turbidity occurs, it is possible to reduce such color turbidity by properly correcting the parameters of the inking processing (color allocating section) on the printing color and minutely cutting/dividing those hard-to-extract areas in the color conversion section 14. Since the input signals are converted to two-state signals of black and red in the proper correction of the parameters of the inking processing section 15, it is possible to easily perform the cutting/dividing operation by deciding a difference value corresponding to the difference between the C signal and other MY signals. The difference signal becomes, for example, smaller if black is involved and greater if red is involved. In order to make the decision based on the difference value, the inking processing by the inking processing section 15 is as follows.

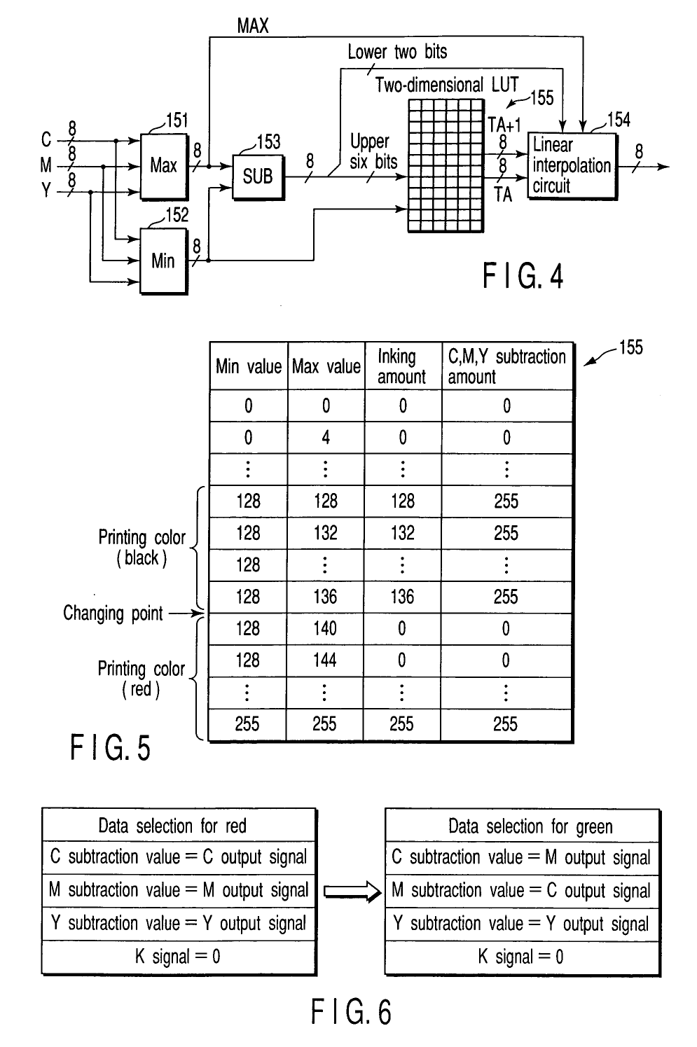

With respect to the converted two-state signals of achromatic and chromatic colors, the inking processing section 15 converts them to printing colors of two colors, for example, black and red, designated on the control panel 12. FIG. 4 is a view showing one form of the inking processing section 15. As shown in FIG. 4, those CMY signals processed by the color conversion processing section 14 are input to a maximum value detection section 151 and minimum value detection section 152. The maximum value detection section (Max) 151 detects a maximum value (Max) and outputs it to a subtraction unit (SUB) 153 and to a linear interpolation circuit 154. The minimum value detection section (Min) 152 detects a minimum value (Min) and outputs it to the subtraction unit (SUB) 153 and to a two-dimensional look-up table (LUT) 155. The subtraction unit 153 outputs upper six bits of the difference between the input maximum value (Max) and the input minimum value (Min) to the two-dimensional LUT 155 and lower two bits to the linear interpolation circuit 154. The two-dimensional LUT 155 outputs data T_{A+1} and T_{A} to the linear interpolation circuit 154 on the basis of the difference (Max−Min) of the upper six bits, on one hand, between the maximum value (Max) and minimum value (Min) coming from the subtraction unit 153 and the minimum value (Min), on the other hand, coming from the minimum value detection section 152. The linear interpolation circuit 154 performs an interpolation between the data T_{A+1} and the data T_{A} and outputs the corresponding data to a subsequent stage processing section. The thus structured inking processing section 15 determines an inking amount (K signal) and CMY subtraction amounts by referring to two kinds of LUT by the minimum value (Min value) and maximum value (Max value) of the CMY signals. Let it be assumed that, for example, two colors black and red are designated as printing colors on the control panel 12. When such designation is made, one color black processing is performed by the inking processing if C=M=Y. In more detail, if C=M=Y, one color black processing is made since the difference between the maximum value and minimum value becomes smaller. That is, LUT is created such that the CMY signals are set to “0”. If C=0 and M=Y (red), “through” processing is made as the inking processing since the Min value is closer to “0”. That is, LUT is created such that C=K=0 and M=Y. In this way, the minimum value and maximum value of the CMY signals are calculated and, based on both the values, inking is made while referring to the inking amount LUT and CMY subtraction amount LUT. Such two kinds of LUT are shown as one example in FIG. 5. The inking amount LUT and CMY subtraction LUT, each, provided a table 155 whose detail is as shown in FIG. 5. The LUT 155, having such a detail, is due to the fact that a greater correlation exists between the inking amount (K signal) and the granularity of an image. Therefore, the detail of the LUT 155 is of a table size necessary to perform a full color printing. Through the utilization of the detail (8512 combinations) of the LUT 155, it is possible to minutely distinguish between the cyan color and other colors. Since the color space is one-dimension-dropped in comparison with processing all at a time on the three-dimensional LUT, it is possible to minutely set the inking amount LUT and CMY subtraction LUT and to realize a two-color printing of less color turbidity.

The printer 16 performs a printing operation based on the CMYK signals processed by the inking processing section 15. If two-color copying is done by designating two colors black and red on the control panel 12, an image of the two colors black and red is output and it is possible to realize two-color copying. Since the printer 16 is of an ordinary type, any further explanation of it is, therefore, omitted.

Now, inking processing will be explained below as being done by the inking processing section 15 when two colors black and green are designated on the control panel 12.

Min value and Max values are calculated from CMY signals input to the inking processing section 15 and reference is made to the inking amount LUT and CMY subtraction LUT. The CMY subtraction LUT has a table for each of CMY colors and a color subtraction value is output from the subtraction from the corresponding colors CMY. After the subtraction value of the CMY signals is output, the CMY signals are selected. This selection operation is performed for selecting CMY signals relative to the CMY subtraction values to allow corresponding ones to be output to the printer 16. That is, at a point in time when the CMY subtraction values have been found, printing colors are not determined which is output to the printer. In the case of a red color, CMY subtraction values are allocated directly to the CMY output signals, while, in the case of a green color, the M subtraction value is allocated to the C output signal and the C subtraction value is allocated to the M output signal. That is, as shown in FIG. 6, in the case of the green as compared with the red, the C and M subtraction values are replaced with the M and C output signals, respectively. By thus allocating such output signals to the CMY subtraction values, it is possible to print a color other than the red color. Further, the subtraction LUT is prepared for each of CMY and, by varying the subtraction amount of each of CMY, it is possible to also print, for example, an orange color.

It is possible for the thus structured image processing apparatus 1 to, without adding any new extra hardware such as an image processing circuit for two-color copying, realize two-color copying with the use of full-color image processing. It is, therefore, possible to achieve a lower hardware cost as well as an improved printing-color conversion accuracy while achieving less color turbidity. Since the conversion accuracy adjustment of the image processing apparatus 1 is one-dimension-dropped to a two-dimension version, it is possible to more readily make parameter adjustment than in the case of calculating a printing color directly from the three-dimensional RGB signal system.

Although, in the present embodiment, the output signals after the color conversion processing are a three-dimensional signal system of CMY, this is tantamount to a substantially two-dimensional signal system because the above-mentioned conversion is made to obtain two-state color signals of black and red.

Although the extraction of colors by the color conversion LUT has been explained in connection with black/red or red/green, the present embodiment is not restricted to such combinations. Although the extraction of the two-states has been explained in connection with the achromatic/chromatic color combination, the present embodiment may use other combinations.

### SECOND EMBODIMENT

Now, an explanation will be made below about the second embodiment of the present invention. In this embodiment, the same reference numerals are employed to designate similar processing to the first embodiment above and any further explanation of the similar processing is, therefore, omitted.

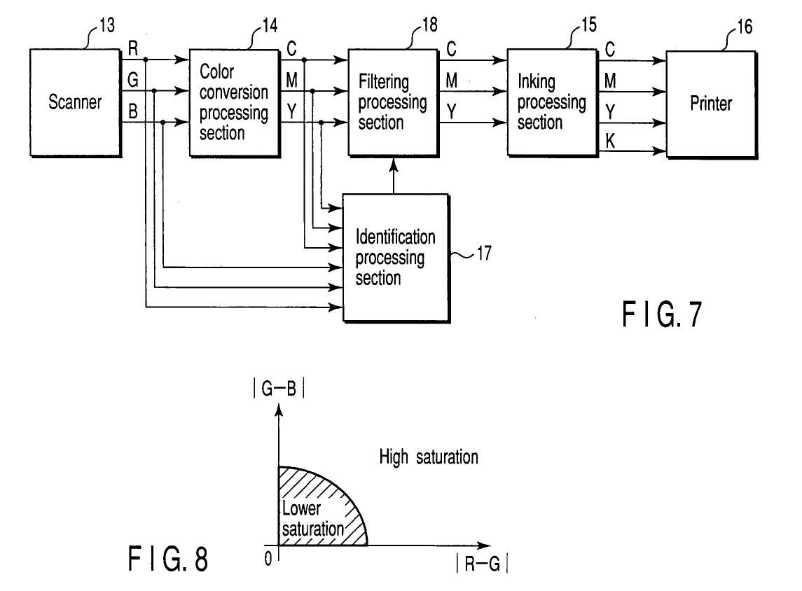

The arrangement of the image processing apparatus of the second embodiment is as shown in FIG. 7. The RGB signals generated at a scanner 13, as well as the CMY signals to which the RGB signals are color-converted on a color conversion section 14, are input to an identification processing section 17. An identification signal from the identification processing section 17 is input to a filtering processing section 18. Further, the filtering processing section 18 is provided between the color conversion processing section 14 and the inking processing section 15. The filtering processing section 18 receives the CMY signals from the color conversion processing section 14 and, after applying the filtering processing to the CMY signals, delivers the corresponding CMY signals to the inking processing section 15.

The identification processing section 17 identifies whether the converted two-state signals from the color conversion processing section 14 are a “character” representing signal or a “picture” representing signal and deliver an identification signal as a result of identification to the filtering processing section 18. That is, the identification processing section 17 identifies whether an image is a character area or a picture area. The identification comprises extracting edge pixels in the image as well as finding a concentration variation within a rectangular area and deciding the image as a character area or a picture area.

The filtering processing section 18 applies low-pass filtering (LPF) and high-pass filtering (HPE) processing to the converted two-state signals from the color conversion processing section 14. The switching of the LPF or HPF is done based on the identification signal from the identification processing section 17. The HPF processing is carried out for those pixels identified as a character representing signal while the LPF processing is carried out for those pixels identified as a picture representing signal.

Then, the image processing will be explained below in the case where two-color copying is input based on the designation of the two colors black and red on a control panel 12. By the color conversion processing section 14, an achromatic area and chromatic area (on the remaining area) in an RGB space are converted to the two-state signals of black and red, respectively, and these signals are input to the identification processing section 17 and to filtering processing section 18. If, at this time, a black, a red and a yellow character are mixed in an input document, the color conversion processing 14 converts the chromatic color such as the red and yellow characters on the document all to a red color signal and delivers the corresponding signal to the identification processing section 17 and to the filtering processing section 18. However, since the yellow color is higher in reflectivity than the red color, even if a red color which is chromatic to the yellow color is generated in the color conversion processing, the concentration varies. That is, even where a solid yellow on the document is scanned by the scanner 13 and allocated to a red signal in the color conversion processing, a corresponding signal is not output as a solid red signal (C=0, M=Y=255). Therefore, in the case where two-color printing is done simply by the concentration conversion of the RGB signals as in the prior art, there occurs a concentration difference for each color on the document. In this way, even if characters of the same chromatic color area are involved, a concentration difference occurs due to the different colors. In order to prevent such a problem, it follows that, in the present embodiment, the changing of those parameters of the identification processing section 17 and filtering processing section 18 is done between the chromatic color and the achromatic color.

Upon receipt of a red signal which is the signal of a chromatic color area, the identification processing section 17, while considering the generation of the concentration difference in the color for a character of each color, is required to relax the threshold value with which the character is identified under the concentration variation. In the case of a black signal which is the signal of an achromatic color area, the reflectivity of RGB is lower and, since even the color converted signal is output as a higher concentration signal, it is possible to narrow the threshold value with which a character is identified under the concentration variation. By independently setting parameters to the converted two-state signals it is possible to improve the quality of the character image.

The changing of the identification parameters in the identification processing section 17 is realized as follows. That is, the saturation is detected from the RGB signals input to the identification processing section 17 and, if it is a lower saturation, identification parameters for the achromatic color are selected while, on the other hand, if it is a higher saturation, the identification parameters for the chromatic color are selected. The decision of the saturation can be obtained by finding |R-G| and |G-B| from the RGB signals. As shown in FIG. 8, the higher/lower saturation is decided based on the saturation information showing the size of a distance from a center (origin) on a two-dimensional plane where an |R-G| axis and |G-B| axis are plotted In the case where the distance from the origin is below a predetermined value, the saturation is decided as a lower saturation and in the case where it is above the predetermined value, the saturation is decided as a higher saturation.

Similarly, even in the filtering processing of the filtering processing section 18, the filtering parameters are independently changed for the two-state signals. For example, the color for a character decided as being a chromatic color has its concentration varied as set out above and the filtering coefficient is set to be higher. That is, strong emphasis is made to set the character concentration higher. For example, on a signal decided as both being a character and being a chromatic color in the identification processing, emphasis processing done, even under a yellow color character, to deliver an output as M=Y=255. Further, even a black signal decided as being an achromatic color has a higher concentration even under a character image and it is possible to reproduce a higher concentration even if the filtering emphasis is not set to be so higher than the coefficient of the chromatic color.

In this way, by independently setting the properly corrected parameters to the converted two-state signals in the identification processing (identification processing section 17) and filtering processing (filtering processing section 18) it is possible to achieve improved reproduction of the character image.

By applying the inking processing to the thus processed signals by virtue of the inking processing section 15, two-color copying is implemented with two colors allocated to printing colors.

Although, in the above-mentioned embodiment, the color conversion is made by the color conversion processing (color conversion processing section 14) to black and red signals, it may be done to other signals. An explanation will be made below about the case of achieving a conversion to two-states of, for example, concentration and saturation signals.

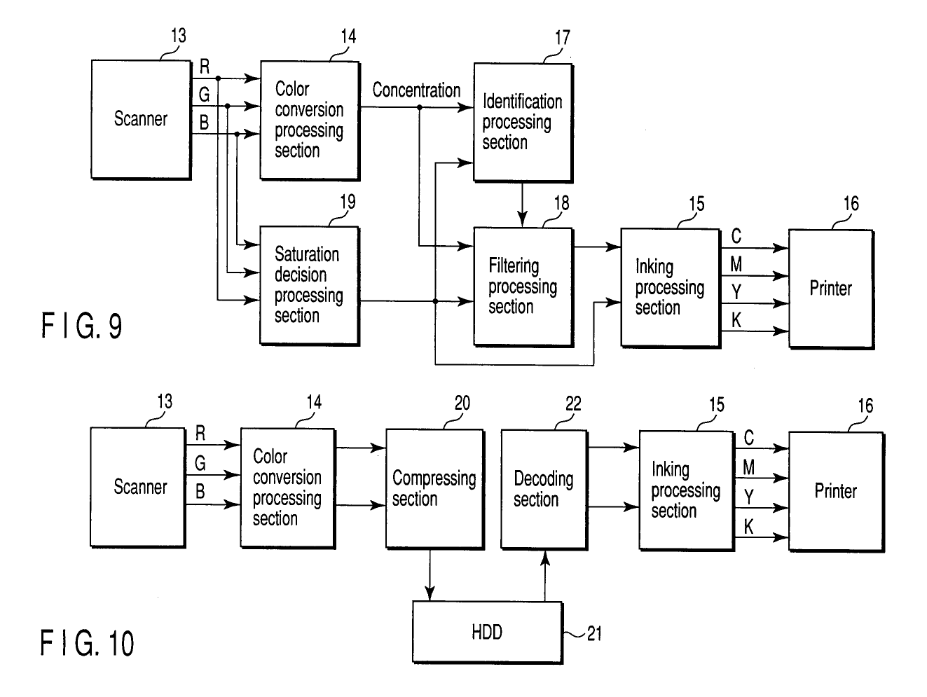

FIG. 9 shows the arrangement of an image processing apparatus applied in this case. As shown in FIG. 9, RGB signals generated by the scanning of a scanner 13 are input to a color conversion processing section 14 and to a saturation decision processing section 19. With respect to the RGB signals received from the scanner 13, the color conversion section 14 calculates a concentration signal (monochrome signal) and delivers a corresponding signal to the identification processing section 17 and to the filtering processing section 18. The identification signal is output from the identification processing section 17 to the filtering processing section 18. Further, saturation information is output from the saturation decision processing section 19 to the identification processing section 17, to the filtering processing section 18 and to the inking processing section 15. A processed signal from the filtering processing section 18 is output to the inking processing section 15. CMYK signals generated in the inking processing section 15 are output to a printer 16.

The conversion by the color conversion section 14 from the RGB signals onto the concentration signal is done with the use of an LUT and the CMY signals in the LUT are set to have all the same value. Further, the saturation decision processing section 19 makes lower/higher saturation decision from the RGB signals. The saturation can be obtained from the RGB signals by finding |R-G| and |G-B|. Thus the lower/higher saturation decision is made as in the same way as set out in connection with FIG. 7. By the processing as set out above, the three-dimensional RGB signal system is converted to a two-dimensional concentration/saturation signal system. In this connection it is to be noted that the concentration signal is so converted as to obtain a concentration=255 against a solid black on a document and that, since in a solid chromatic color on a document a concentration≠255, it is not possible to print out a solid concentration as an output. The concentration difference between the achromatic color and the chromatic color is the same as set out in connection with the above-mention embodiment and this is handled by the identification processing (identification processing section 17) and filtering processing (filtering processing section 18).

The identification processing section 17 calculates, with respect to the two-dimensional concentration/saturation signal system, an edge detection from the concentration signal and a concentration variation within a rectangular area and decides whether an associated signal is a character representing signal or a picture representing signal. At this time, the identification parameters of the identification processing section 17 are changed based on the saturation signal which is output from the saturation decision processing section 19. Stated in more detail, if an image is in a lower saturation, it is an achromatic color and the corresponding achromatic color identification parameters are selected. If an image is in a higher saturation, it is a chromatic color and the corresponding chromatic color identification parameters are selected.

In the filtering processing of the filtering processing section 18, similarly, with respect to the received concentration signal, the filtering parameters are changed based on the saturation signal which is output from the saturation decision processing section. That is, if the identification signal is decided as a character representing signal and the saturation information is a high saturation (chromatic color) representing signal, filtering parameters are so selected as to output a value=255 under emphasis processing.

The inking processing section 15 is such as to allow, in response to an identification-processed and filtering-processed monochrome signal, printing to be made in black color (K=monochrome signal) if an involved signal represents a lower saturation signal on the basis of the saturation signal of the saturation decision processing section 19 and printing to be made in red (C=K=0, M=Y=monochrome signal) if an involved signal represents a higher saturation signal.

By changing, as set out above, the parameters of the identification processing section 17, filtering processing section 18 and inking processing section 15 with respect to the converted two-state signals of the concentration and saturation signals and, by doing so, performing proper correction processing, it is possible to improve the reproduction of a character image. Since the identification processing and filtering processing are also used in full-color printing and can be realized simply by changing the parameters for two-color printing use, these can be so done at low cost without the need to add any new circuits.

Although, in this second embodiment, the color extraction is made in a black/red combination by referring to the color conversion LUT, any other proper combination may be used. Further, the two-state extraction is made under the achromatic/chromatic colors, any other proper combination may be made.

### THIRD EMBODIMENT

An explanation will be made below about the third embodiment of the present invention. In this case, the same reference numerals are employed to designate processing similar to that in the second embodiment and any further explanation of them is, therefore, omitted. The arrangement of the image processing apparatus of the third embodiment is the same as set out in connection with FIG. 7.

In the case where, in the image processing, two-color copying is designated, with the same colors, on a control panel 12, reproduction emerges in a single-color mode. If a single-color mode is realized in the two-color copying, there is a demand for reproduction to be effected in the same concentration as that realized in conventional single-color copying. It is, therefore, desired, on the part of the user, that, without distinguishing between the case of obtaining a single-color mode color output in two-color copying and the case of obtaining a single-color output mode in a single-color-entry color output system, the same result of output be secured in either case. It is thus necessary to secure single-color mode color reproduction even in two-color copying. In order to realize single-color mode color copying in two-color copying, therefore, the parameters of the color conversion processing of the color conversion processing section 14 and parameters of the filtering processing of the filtering processing section 18 are so set as will be given below.

First, in the color conversion processing section 14, the values of the color conversion LUT are used as an LUT for single-color copying. Since, in this case, two-color copying is done (set), a cyan value of a chromatic color range is set to 0. By this setting operation, converted two-state signals output after the color conversion processing become signals for ensuring the same concentration reproduction as that of single-color copying. With respect to the signals for the same concentration reproduction, use is made of the same filtering coefficient of the filtering processing section 18 as that of the two-state signals. This ensures the same concentration reproduction of the filter-processed signals.

By the subsequent inking processing of the inking processing section 15 the same and designated color is allocated to the two-state signals and the corresponding signal is output. Even if the same printing color is allocated to the printing colors of the two colors, it is possible to realize the same concentration reproduction as that of single-color copying, that is, the same tone characteristic/image quality reproduction, and it is thus possible to obtain a better image.

In addition to the effect of the above-mentioned method, the same effect can also be obtained in the case of a concentration signal and color difference signal. An explanation will be made below about a method. The image processing scheme is the same as set out above and any further explanation of it is, therefore, omitted. In the same way as set out in connection with the second embodiment, the color conversion processing section 14 converts the RGB signals to a concentration signal. In connection with such different concentration reproduction signals, the same parameter setting is made to the concentration signal in the identification processing section 17 and filtering processing section 18. The corresponding processing is done by the identification processing 17 and filtering processing section 18 and, to the processed concentration signal from the filtering processing section 18, the same and printing color is allocated by the inking processing section 15. Even in this case, it is possible to obtain the same effect as set out in connection with the above-mentioned method.

In the third embodiment, although the two-state extraction is carried out as an achromatic/chromatic combination, any other proper combination may be used.

### FOURTH EMBODIMENT

An explanation will be made below about the fourth embodiment of the present invention. Here, the same reference numerals are employed to designate the processing corresponding to those in the first embodiment of the present invention and any further explanation of them is, therefore, omitted.

FIG. 10 shows the arrangement of an image processing apparatus according to the fourth embodiment. As shown in FIG. 10, the image processing apparatus is such that, between a color conversion processing section 14 and an inking processing section 15, a compressing section 20, a hard disk drive (HDD) 21 and decoding section 22 are provided, the HDD 21 serving as a storage section.

The compressing section 20 performs compression processing on color-conversion-processed two-state signals coming from the color conversion processing section 14. This compression processing is done, for example, under the joint photographic expert group (JPEG) compression system. The JPEG compression method, being of a general compression type, has its explanation omitted. Although the JPEG method is used as the compression processing by the compressing section 20, any other proper compression processing may be used.

An explanation will be made below about the flow of the thus described image processing. In the color conversion processing of the color conversion processing section 14 as set out above, RGB signals are converted, for example, to an achromatic (black) color and chromatic (red) color. Then, compression processing is performed, by the compressing section 20, on the thus converted two-state signals and a compressed signal is stored in the HDD 21. This storage of the thus compressed signal in the HDD 21 is done because a plurality of document sheets are sequentially fed in place by the ADF, not shown, in a sheet-by-sheet fashion, continuously scanned by a scanner 13 on the sheet-by-sheet basis and stored in the HDD 21 with the thus scanned signal of a larger capacity compressed to a smaller capacity. By storing the image signal in the HDD 21 it is possible to independently separate the scanning operation by the scanner 13 and printing operation by the printer 16 and hence to improve the operability of an image processing apparatus. Since the scanner 13 performs a continuous operation, it is necessary that the transfer rate of the HDD 21 be made higher according to the scanning speed of the scanner 13 and size of the compressed image signal. Then, the signal is read out from the HDD 21 and sent to the decoding section 22 for decoding. By the inking processing of the inking processing section 15, printing colors of two colors are allocated to the decoded signals and printing is done by a printer 16.

It is to be noted that three positions may be considered as the position of the compression processing on the signal. As a first position, there is a position (before the color conversion processing) at which compression/decoding is performed at a point in time when the RGB signals are input. As a second position, there is a position (after the color conversion processing) at which compression/decoding is performed on the two-state signals. As a third position there is a position (after the inking processing) at which compression/decoding is performed after printing colors are allocated.

In the first position, a compression signal amount becomes greater because the input signals are RGB signals and it is necessary to secure a higher transfer rate in the HDD 21 and a larger-capacity storage area. In the third position, if the printing colors of two colors are, for example, red and green, it is necessary to compress the two-state signals as color images. In this case, the compression signal amount becomes greater as in the case of the first position and it is necessary to secure a higher transfer rate in the HDD 21 and a larger-capacity storage area. In the second position, on the other hand, since two-state signals such as achromatic color (black) and chromatic color (red) are involved, a color signal can be eliminated from the achromatic color signal and it is possible to reduce that compression signal amount. As set out above, the signal amount can be reduced by performing the compression and decoding of the converted two-state signals. It is, therefore, not necessary to secure a higher transfer rate in the HDD 21 and a greater-capacity storage area. As a result, the hardware cost for the HDD 21 can be mode lower.

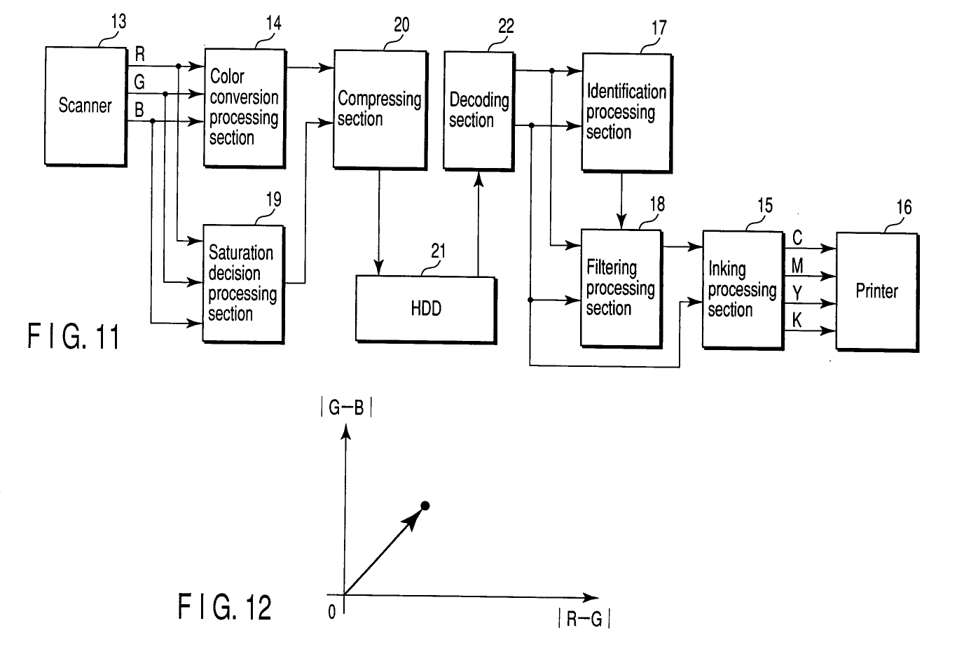

Although, in the explanation above, two-state signals input to the compressing section 20 are used as black and red, even if these signals are input as a luminance and saturation state, it is possible to reduce the compression signal amount. FIG. 11 shows the arrangement of an image processing apparatus in the case where conversion is made to two-state signals of luminance and saturation. As shown in FIG. 11, a compression section 20, HDD 21 and decoding section 22 are provided between a color conversion processing section 14 and a saturation decision processing section 19 and between an identification processing section 17 and a filtering processing section 18.

Now, an explanation will be made below about the operation flow of the image processing apparatus thus structured. The color conversion section 14 performs color conversion processing on received RGB signals and outputs a concentration signal (monochrome signal) by calculation. By the saturation decision processing of the saturation decision processing section 19, a lower saturation and higher saturation are detected from the RGB signals. The detection of the saturation can be obtained by finding |R-G| and |G-B| from the RGB signals. As shown in FIG. 12, a saturation signal is detected which represents the distance from the center (origin) on a two-dimensional plane where an |R-G| axis and |G-B| axis are plotted. Based on the saturation signal, for example, saturation decision is made as being a lower saturation when the distance from the origin is lower than a predetermined value and as being a higher saturation when the distance from the origin is greater than the predetermined value. The concentration signal and saturation signal thus calculated are input to the compression section 20. The JPEG compression by the compression section 20 is done with the Y (luminance), Cb (color difference) and Cr (color difference) signal, and the corresponding compressed signal is stored in the HDD 21. In this embodiment, the concentration signal is allocated to the Y (luminance) signal and the saturation signal is allocated to the Cb (color difference) signal. Since no signal is allocated to the Cr (color difference), it is not necessary to provide any corresponding compression portion. By effecting, in this way, conversion to a two-dimensional signal of the concentration signal and saturation signal and effecting the JPEG compression, one color difference signal is not necessary and it is possible to reduce the compression signal amount and size of the HDD 21. The compressed signal stored in the HDD 21 is decoded at the decoding section 22. The decoded concentration signal and saturation signal are output to the identification processing section 17 and filtering processing section 18. The subsequent processing is the same as explained with reference to FIG. 6 and any further explanation of it is, therefore, omitted.

In this structure, by performing compression processing under two-states of the concentration signal and saturation signal, it is possible to reduce the compression signal amount stored in the HDD 21. It is also possible to reduce hardware costs without the need for speeding up the transfer rate of the HDD 21 and securing a larger-capacity storage area.

Although the above-mentioned embodiment has been explained as being applied to two-color copying, the embodiment is not necessarily restricted thereto. For example, the present invention can also be applied to an image processing apparatus having a network function in the case where network scanning is carried out.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An image processing apparatus comprising:
an input section configured to receive color image signals;
a printing color designating section configured to designate printing colors of two colors;
a conversion section configured to receive the color image signals which are received from the input section and to convert the color image signals to two-state signals in a dimension-dropped fashion; and
a color allocation section configured to allocate the printing colors of two colors which are designated by the printing color designating section to the converted two-state signals.

2. An image processing apparatus according to claim 1, wherein the conversion by the conversion section is a color conversion.

3. An image processing apparatus according to claim 1, wherein the allocation of the printing colors by the color allocation section is inking processing.

4. An image processing apparatus according to claim 2, wherein the color conversion is done under a look-up table system.

5. An image processing apparatus according to claim 1, further comprising identification processing section configured to identify whether, with respect to the converted two-state signals, a character is represented or a picture is represented and to independently set parameters of the identification processing to the two-state signals.

6. An image processing apparatus according to claim 1, further comprising a filtering processing section configured to perform filtering processing on the converted two-state signals and to independently set parameters of the filtering processing to the converted two-state signals.

7. An image processing apparatus according to claim 1, further comprising an identification processing section configured to identify whether, with respect to the converted two-state signals, a character signal is represented or a picture signal is represented and to independently set parameters of the identification processing to the two-state signals and a filtering processing section configured to perform filtering processing on the converted two-state signals and independently set parameters of the filtering processing to the two-state signals, wherein, when the two color designation is made with the same color on the printing color designating section, the filtering processing section has its parameters set to allow the converted two colors from the conversion section to be printed as the same concentration reproduction.

8. An image processing apparatus according to claim 1, further comprising a compression section configured to independently perform compression processing on the converted two-state signals from the conversion section, a storage section configured to store the compressed two-state signals from the compression section, and a decoding section configured to perform decoding processing on the compressed two-state signals which are stored in the storage section.

9. An image processing method comprising:
designating printing colors of two colors;
converting input color image signals to two-state signals in a dimension-dropped fashion; and
allocating the designated printing colors of two colors to the converted two-state signals.

10. An image processing method according to claim 9, wherein the converting step is done by color conversion processing.

11. An image processing method according to claim 9, wherein the allocating is done by inking processing.

12. An image processing method according to claim 10, wherein the color converging processing is done under a look-up-table system.

13. An image processing method according to claim 9, further comprising identification processing is done for identifying whether, with respect to the converted two-state signals, a character signal is represented or a picture signal is represented and parameters of the identification processing are independently set to the two-state signals.

14. An image processing method according to claim 9, further comprising filtering processing is done on the converted two signals and parameters of the filtering processing are independently set to the two-state signals.

15. An image processing method according to claim 9, further comprising identification processing operation is done for identifying whether, with respect to the converted two-state signals, a character signal is represented or a picture signal is represented and parameters of the identification processing are independently set to the two-state signals, and filtering processing is done on the converted two-state signals and parameters of the filtering processing are independently set to the two-state signals, wherein if the two color designation is done with the same color, the parameters of the identification processing and parameters of the filtering processing are so set that the converted two-state signals can be printed in the same concentration reproduction.

16. An image processing method according to claim 9, further comprising compression processing is done independently on the converted two-state signals, storing the compressed two-state signals, and decoding processing is done on the stored compressed two-state signals.
